(19) United States
(12) Patent Application Publication
(10) Pub. No.: US 2025/0291549 A1
(43) Pub. Date: Sep. 18, 2025

(54) GENERATING MULTIPLY AND ACCUMULATION CALCULATION RESULTS WHILE REDUCING POWER CONSUMPTION AND INCREASING PERFORMANCE

(71) Applicant: Taiwan Semiconductor Manufacturing Company, Ltd., Hsinchu (TW)

(72) Inventor: Hiroaki Ishii, Hsinchu City (TW)

(73) Assignee: Taiwan Semiconductor Manufacturing Company, Ltd., Hsinchu (TW)

(21) Appl. No.: 18/606,792

(22) Filed: Mar. 15, 2024

(51) Int. Cl. G06F 7/523; G06F 7/50

(52) U.S. Cl. CPC G06F 7/523; G06F 7/50

(57) ABSTRACT

A system and method of operating the system are disclosed. In one aspect, a system includes a memory circuit storing data for a compute-in-memory (CIM) operation. The system includes an adder circuit receiving a plurality of inputs from a plurality of input devices and the memory circuit. The system includes a comparison circuit configured to receive a configuration input and generate a disable signal, the disable signal configured to disable at least a portion of the adder circuit during the CIM operation.

### BACKGROUND

An integrated circuit (IC) can contain a variety of hardware circuit devices or types of logic, including FPGAs, application-specific integrated circuits (ASICs), logic gates, registers, or transistors, in addition to various interconnections between the circuit devices. The IC can be manufactured using or composed of semiconductor materials, for instance, as part of electronic devices, such as computers, portable devices, smartphones, internet of thing (IoT) devices, etc. Developments and increasing complexity of the ICs have prompted increased demands for higher computational efficiency and speed. More specifically, the ICs can be configurable and/or programmable to perform computations in sequences or variations desired by the manufacturer, developer, technician, or programmer, among others.

### BRIEF DESCRIPTION OF THE DRAWINGS

Aspects of the present disclosure are best understood from the following detailed description when read with the accompanying figures. It is noted that, in accordance with the standard practice in the industry, various features are not drawn to scale. In fact, the dimensions of the various features may be arbitrarily increased or reduced for clarity of discussion.

FIG. 1 illustrates a schematic block diagram of an example system including an example multiply-accumulate (MAC) circuit implemented to execute compute-in-memory (CIM) operations, in accordance with some embodiments of the present disclosure.

FIG. 2 illustrates a block diagram of an example comparison circuit for generating control signals for components of the MAC circuit shown in FIG. 1, in accordance with some embodiments of the present disclosure.

FIG. 3 illustrates a block diagram of showing how example adder circuits of a MAC circuit are controlled by the comparison circuit shown in FIG. 2, in accordance with some embodiments of the present disclosure.

FIG. 4 illustrates an example block diagram showing how the precision of example floating point numbers are modified according to the signals generated by the control circuit shown in FIG. 2, in accordance with some embodiments of the present disclosure.

FIG. 5 illustrates a block diagram of another example comparison circuit that generates additional control signals for components of an example MAC circuit generated based on a threshold for increasing the performance of the MAC circuit, in accordance with some embodiments of the present disclosure.

FIG. 6 illustrates a block diagram of showing how example adder circuits of a MAC circuit are controlled by the comparison circuit shown in FIG. 5, in accordance with some embodiments of the present disclosure.

FIG. 7 illustrates a flowchart of an example method to operate the disclosed circuits described herein, in accordance with some embodiments of the present disclosure.

### DETAILED DESCRIPTION

The following disclosure provides many different embodiments, or examples, for implementing different features of the provided subject matter. Specific examples of components and arrangements are described below to simplify the present disclosure. These are, of course, merely examples and are not intended to be limiting. For example, the formation of a first feature over, or on a second feature in the description that follows may include embodiments in which the first and second features are formed in direct contact and may also include embodiments in which additional features may be formed between the first and second features, such that the first and second features may not be in direct contact. In addition, the present disclosure may repeat reference numerals and/or letters in the various examples. This repetition is for the purpose of simplicity and clarity and does not in itself dictate a relationship between the various embodiments and/or configurations discussed.

Further, spatially relative terms, such as “beneath,” “below,” “lower,” “above,” “upper” “top,” “bottom” and the like, may be used herein for ease of description to describe one element or feature's relationship to another element(s) or feature(s) as illustrated in the figures. The spatially relative terms are intended to encompass different orientations of the device in use or operation in addition to the orientation depicted in the figures. The apparatus may be otherwise oriented (rotated 90 degrees or at other orientations) and the spatially relative descriptors used herein may likewise be interpreted accordingly.

Digital compute-in-memory (DCIM) devices include circuits that combine memory and computation in the same physical location. By placing computational circuitry directly within memory storage circuits, data does not need to be transmitted as far to other processing circuits, which reduces computational latency and overall power consumption. Computational circuitry can include accumulator devices, such as multiplier-accumulator (MAC) circuits that efficiently process memory information for a variety of use-cases, including machine-learning, matrix/vector multiplications, or general parallel computing.

In the context of machine learning, CIM circuits provide significant performance improvements, particularly in the context of large, parallel multiplication operations (e.g., matrix multiplications). The parallelism inherent in CIM architectures enable simultaneous processing of multiple data points, leading to faster training and inference times for neural networks. Additionally, the efficiency improvement from reducing data movement contribute to more scalable and energy-efficient devices and systems. Example CIM circuits that implement such technology include CIM architectures that perform MAC operations for floating-point data.

Floating-point data can be represented according to a variety of bit-widths, each of which providing a corresponding level of precision. One example of such precision is 32-bit floating point data, which includes a single sign bit, an 8-bit exponent, and a 23-bit mantissa, to represent a decimal value. Another example of floating-point data is 16-bit floating-point data, which includes a single sign bit, a 5-bit exponent value, and a 10-bit mantissa.

Different applications may utilize, or otherwise rely on, different floating point precision values during MAC operations. However, because conventional MAC circuits are designed to accommodate larger precision values, such as 32-bit or 64-bit floating point values, the MAC circuits often activate more components than necessary when performing lower-precision operations. For example, if a 32-bit MAC circuit is performing a MAC CIM operation on 16-bit numbers, the entire MAC circuit is still active, despite several values in the MAC circuit being unused. This results in an overall increase in power consumption and may slow device performance as the propagation times for values generated by circuits unnecessary for lower-precision calculations may prevent faster clock signals from being utilized.

To address these and other issues, the techniques described herein provide control circuits that automatically disable portions of MAC circuits that are unnecessary for lower-precision floating-point operations. Such techniques can be used to effectively reduce overall power consumption during operations having lower precision that the maximum precision of the MAC circuits. Additionally, in some implementations, decreasing the number of components activated during lower-precision operations decreases the largest signal propagation time, enabling selectively faster clock speeds and therefore improved performance for lower-precision operations. Further, the control circuits described herein can be configurable, such that any portion of the MAC circuits described herein can be activated or deactivated according to a programmable precision value.

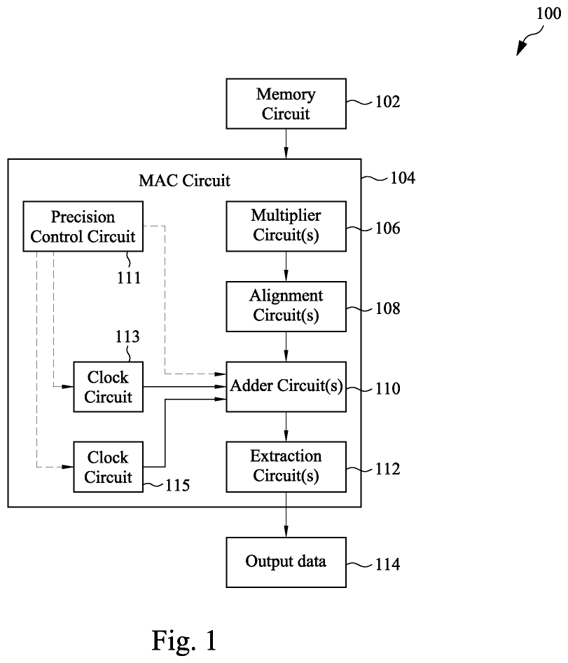

FIG. 1 illustrates a schematic block diagram of an example CIM system 100 including an example memory circuit 102 to execute various CIM operations, including MAC operations, in accordance with some embodiments of the present disclosure. A CIM system is a system in which computational components, such as the MAC circuit 104 (which is shown as including one or more multiplier circuits 106, alignment circuits 108, adder circuits 110, and extraction circuits 112), are defined in connection with one or more memory components (e.g., a memory circuit 102). The CIM system 100 is shown as including a memory circuit 102 and a MAC circuit 104, which may utilize the data stored in the memory circuit 102 (e.g., floating-point data of varying precision) to perform MAC operations and generate corresponding output data 114.

The CIM system 100 may include one or more logic gates and sub-circuits, each of which may be constructed from one or more logic gates. Logic gates are electronic devices that perform logical operations on one or more input signals to produce a single output signal. Various embodiments of the circuits and logic gates that implement the CIM system 100 may include various transistors. The transistors described herein may have a certain type (n-type or p-type), but embodiments are not limited thereto. The transistors can be any suitable type of transistor including, but not limited to, metal oxide semiconductor field effect transistors (MOSFET), complementary metal oxide semiconductors (CMOS) transistors, P-channel metal-oxide semiconductors (PMOS), N-channel metal-oxide semiconductors (NMOS), bipolar junction transistors (BJT), high voltage transistors, high frequency transistors, P-channel and/or N-channel field effect transistors (PFETs/NFETs), FinFETs, planar MOS transistors with raised source/drains, nanosheet FETs, nanowire FETs, or the like.

As shown, the CIM system 100 can include a memory circuit 102, which can include any type of memory circuit that can store data for CIM operations, including matrix multiplication operations using floating-point data. The memory circuit 102 can include any number of memory cells in any configuration suitable for CIM operations and may include but are not limited to static random-access-memory (SRAM) cells, dynamic random-access-memory (DRAM) cells, flash memory cells, programmable fuses (e.g., eFuses, etc.), or any other type of memory circuit. In some implementations, the memory circuit may provide values for various CIM operations, including matrix multiplications. As shown, the memory circuit 102 can be in communication with, or in some implementations can include the MAC circuit 104.

The MAC circuit 104 can be any type of circuit that can be used to perform multiply-accumulate operations, including floating-point multiply-accumulate operations. As shown, the MAC circuit 104 can include various components, including one or more multiplier circuits 106, one or more alignment circuits 108, one or more adder circuits 110, and one or more extraction circuits 112. In some implementations, one or more of the components may be included as part of the memory circuit 102. For example, the memory circuit 102 may be or include a memory array, with each cell in the memory array including an SRAM component that stores one or more floating-point values (e.g., a floating-point mantissa and a floating-point exponent and sign value).

The stored floating-point values in each memory cell may be weight values for a machine-learning operation (e.g., a matrix multiplication), or any other type of CIM operation (e.g., a MAC operation, an addition operation, etc.). In some implementations, each of the memory cells in the memory array may include one or more multiplier circuits 106, which may perform at least a portion of a floating-point multiplication operation. For example, each memory cell may receive an input operand value stored as floating-point data. In such implementations, the memory cells can include multiplier circuits 106 that perform multiplication operations between the mantissa values of data stored in the memory cells (e.g., SRAM components) and the mantissa value of input data. Similarly, each of the memory cells may include an adder circuit 110 that performs an addition operation between each of the exponent values of the stored data and the input data, as part of a multiplication operation. The outputs of each cell may include a mantissa product and an exponent sum, each of which may be provided as input to a respective alignment circuit.

Cells in the memory circuit 102 may be arranged in a two-dimensional array. In one example, each row in the array of the memory circuit may include sixty-four cells, with each cell providing a respective output mantissa product and exponent sum. Each row of cells in the array can therefore provide a set of output data, each of which can be provided as input to a respective alignment circuit 108. Alignment circuits 108 can both extend and shift the mantissa values of each output floating-point mantissa produced by each cell in a row. Each shift operation can be performed on the mantissa values of each output, such that the exponents all floating-point values produced by the row of the memory circuit 102 are equal to one another. When all exponent values are equal to one another, the mantissa values can be summed together directly using one or more adder circuits 110, to perform an accumulation operation.

In some implementations, in a MAC operation, all resulting products produced by a row of the memory circuit 102 can be summed together using a corresponding adder circuit 110. The adder circuit 110 can be any suitable adder circuit, and may include one or more adder trees, full adder circuits, as well as carry-generation and/or carry lookahead logic. The adder circuits 110 may include multiple full adders, or portions, each of which generate a respective bit of a total sum (e.g., the sum of all shifted mantissa values generated via the alignment circuits 108). Each respective adder circuit 110 may receive power from one or more voltage sources, which may be provided or controlled by a power circuit 115. Additionally, each respective adder circuit 110 may receive one or more clock signals from a corresponding clock circuit 113.

The clock circuit 113 can include various logic gates, transistors, or other circuit elements that generate or otherwise provide a clock signal to the one or more adder circuits 110. The clock circuit 113 may control a frequency of the clock signal provided to one or more adder circuits 110, or any additional circuit elements of the MAC circuit 104. The clock signals can be synchronized square wave signals transmitted at a predetermined duty cycle and frequency. The clock signals may cause flip-flops or other circuit elements to change state. The clock circuit 113 can include one or more buffers or drivers that can amplify one or more clock signals to ensure that said clock signal(s) maintain their integrity as they are provided to one or more components of the MAC circuits 110. In some implementations, the clock circuit 113 can include controllable elements that can remove or stop a clock signal (e.g., by causing it to stop changing logical states, etc.) to different elements or components of the MAC circuit 104. For example, the clock circuit 113 may receive signals from a precision control circuit 111, as described in further detail herein, to stop providing a clock signal to one or more portions of the adder circuits 110. Although shown as internal to the MAC circuit 104, it should be understood that in some implementations, the clock circuit 113 may be external to the MAC circuit 104.

The power circuit 115 can include various logic gates, transistors, or other circuit elements that provide or otherwise control supply power to one or more components of the MAC circuit 104, including the one or more adder circuits 110. The power circuit 115 can include one or more transistors, buffers, and/or switching circuits that can selectively provide and/or remove power from various components of the MAC circuit 104. In some implementations, the power circuit 115 can include controllable logic elements that can remove or reduce supply voltage to different elements or components of the MAC circuit 104. For example, the power circuit 115 may receive signals from a precision control circuit 111, as described in further detail herein, switch off, disconnect, or otherwise remove a supply voltage from one or more portions of the adder circuits 110 (or other components of the MAC circuit 104). Although shown as internal to the MAC circuit 104, it should be understood that in some implementations, the power circuit 115 may be external to the MAC circuit 104

The precision control circuit 111 can include various logic gates, transistors, and/or other functional logic circuits to generate signals that control whether portions of the MAC circuit 104 are active during CIM operations. The precision control circuit 111 can selectively deactivate one or more portions of the adder circuits 110, the alignment circuits 108, the extraction circuits 112, or otherwise modify the logical operations thereof by generating and providing corresponding control signals. In some implementations, control signals can be generated that are provided as inputs to enable signals of one or more adder circuits 110 (or any components or circuit elements thereof). Various techniques can be utilized to deactivate portions of the MAC circuit 104, including clock-based control signals, power-based control signals, or device enable-based control signals, among others.

In some implementations, the precision control circuit 111 can generate control signals for the power circuit 115 to selectively remove power from one or more components of the MAC circuit 104. In some implementations, the precision control circuit 111 can generate control signals for the clock circuit 113 to selectively deactivate a clock signal to one or more components of the MAC circuit 104. In some implementations, the precision control circuit 111 can generate control signals that activate or deactivate logical enable inputs of various components of the MAC circuit 104. Combinations of the aforementioned techniques may also be utilized to minimize power consumption by disabling portions of the MAC circuit 104 that are unnecessary for a given floating-point operation having a given precision. Although various control signals (which are represented by arrows extending to and from the precision control circuit 111, the clock control circuit 113, and the power circuit 115) are shown as being provided to the adder circuit(s) 110, it should be understood that said control signals may be provided to any portion of the MAC circuit 104 to achieve useful results.

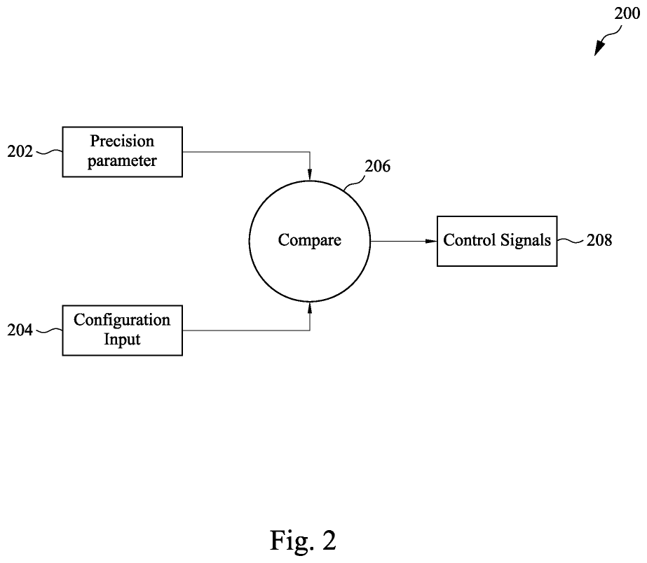

The precision control circuit 111 may include one or more memory elements (e.g., eFuse, registers, latches, SRAM, etc.) that store configuration inputs for generating the control signals for the MAC circuit 104. Such memory elements may be initialized or configured from external logic systems, which may form a part of the same or different semiconductor device or system within which the CIM system 100 is defined. For example, in some implementations, the CIM system 100 may include a configuration circuit that configures storage elements of the precision control circuit 111, for example, upon device/system reset or during a configuration process. Further details of the precision control circuit 111, and control signals generated thereby, are described in connection with FIGS. 2-6.

Referring to FIG. 2, illustrated is a block diagram of an example comparison circuit 200 for generating control signals 208 for components of a MAC circuit (e.g., the MAC circuit 104 shown in FIG. 1), in accordance with some embodiments of the present disclosure. The comparison circuit 200 may be implemented as part of a CIM system (e.g., the CIM system 100 of FIG. 1). In some implementations, the comparison circuit 200 may be implemented as, or as part of, a precision control circuit for floating-point CIM operations (e.g., the precision control circuit 111, etc.). The comparison circuit 200 is shown as including a precision parameter 202, a configuration input 204, a comparison device 206, and one or more control signals 208.

The precision parameter 202 can be a predetermined value representing a maximum precision of a MAC circuit (or other type of addition-including circuit) that may be implemented to perform CIM operations. In one example, a CIM operation may be a multiplication operation between two 16-bit floating point values, resulting in an output of a 32-bit accumulated sum. Furthering this example, the operation may be a matrix multiplication operation between matrices having 16-bit floating-point values stored in respective cells of a memory array, as described herein. Performing a MAC operation during a matrix multiplication can result in a 32-bit floating point accumulator value, making the resulting maximum precision of the MAC circuit 32. However, the precision parameter 202 is not limited to 32-bits of precision, and instead may be any value corresponding to a maximum number of adders required to carry out addition of any number of floating-point values.

For example, and as described in further detail herein, certain floating-point accumulation operations may utilize least-significant bit (LSB) extension and/or most-significant bit (MSB) extension to accommodate for alignment and/or additional carry values to accommodate sums between arbitrary numbers of floating-point mantissa values. For example, carry extension (e.g., MSB extension) may utilize additional carry bits (and therefore adders) when implementing adder trees that accumulate more than two floating-point mantissa values. The number of extra MSB bits may be a function of the number of sums (e.g., a log base-2 of the number of sums). In some implementations, LSB extension may be utilized to accommodate for alignment between different exponent values during addition, where the mantissa values are shifted according to differences in exponent values, such that the exponent values are equal to enable direct addition of mantissa values of the floating-point numbers. In situations where several floating-point values are summed (e.g., in a MAC CIM operation), LSB extension can be performed to preserve floating-point precision across multiple sums.

The precision parameter 202 can be stored as any type of value that represents the maximum number of activate adders in the CIM circuit to achieve maximum precision. In some implementations, the precision parameter 202 may be stored as a numerical value in binary format. In some implementations, the precision parameter 202 may be stored in another type of encoded format (e.g., a number of binary values corresponding to the maximum number of activate adders). In some implementations, the precision parameter 202 may be stored in one or more memory elements (e.g., eFuses, flash memory, SRAM, latches, registers, etc.) and can be retrieved or otherwise accessed by the comparison device 206 as described herein.

The configuration input 204 can be any type of configuration data that may be utilized to specify a desired precision for the CIM system during, for example, MAC operations. The configuration input 204 can specify a number of adder devices or circuits that are to be disabled to achieve a desired degree of precision. In one example, to facilitate generation of 16-bit floating point outputs when the precision parameter 202 for the MAC circuit causes generation of 32-bit floating point outputs, the configuration input 204 can indicate that the least-significant 13 adders of the MAC circuit are to be disabled. The configuration input 204 can be stored as any suitable of value, such as a binary number value or an encoded binary indication (e.g., a register of binary values with each position corresponding to a respective adder and having a value that identifies whether said adder is activated or deactivated). In some implementations, the configuration input 204 can store a desired precision (e.g., number of active adders/circuits) for a CIM/MAC operation.

The configuration input 204 can be stored in any suitable programmable memory element, such as an SRAM, flash memory, register(s), latch(es), or other electronically-programmable memory elements. In some implementations, the configuration input 204 can be set at device reset or in response to a corresponding write command from external configuration circuit(s). In some implementations, the configuration input 204 can be set on a per-operation basis, and may be provided with the input data that is to be utilized for the MAC/CIM operation. In some implementations, the configuration input 204 may be reset to activate all adder circuits upon completion of a MAC/CIM operation. In some implementations, the configuration input 204 may retain its value for subsequent MAC/CIM operations, until reset or modified by external circuitry. The configuration input 204 can be retrieved by, provided to, or utilized by the comparison device 206 to generate the control signals 208.

The comparison device 206 can be any type of logic device and/or transistor circuit that can generate one or more control signals 208 based in the input precision parameter 202 and the configuration input 204. In an implementation where the configuration input 204 specifies a number of adders that are to be active during a CIM/MAC operation (e.g., a desired precision), the comparison device can include a subtraction circuit that subtracts the numerical value of the configuration input 204 from the numerical value of the precision parameter 202. In implementations where the configuration input 204 specifies a number of adders/circuits to disable during the CIM/MAC operation to achieve a desired precision, the comparison device 206 can compare the configuration input 204 to a minimum required precision (which may be specified as part of the precision parameter 202). If the configuration input 204 is greater than the minimum required precision, or greater than the precision parameter 202, the comparison device generate control signals 208 that activate a minimum number or maximum number of adders/circuits of the MAC circuit.

In some implementations, the comparison device 206 can use one or more of the aforementioned techniques to determine a number of adder circuits to activate and/or deactivate. The comparison device 206 can include logic gates, circuit elements, or other devices that can map the number of activated/deactivated adders/circuits of the MAC circuit to corresponding activation/deactivation control signals 208. In doing so, the comparison device 206 can generate control signals 208 to activate and/or deactivate one or more circuit elements of the MAC circuit to achieve a desired precision, without losing information in the process. For example, the comparison device 206 can generate enable signals (e.g., the control signals 208) for each adder circuit in a MAC circuit. Furthering this example, the MAC circuit can include logic gates, circuit elements, or other devices can set each of the enable signal, starting from the adder/circuit in the least-significant bit position, to a logically disabled state, up to the number of adders/circuits that are to be disabled. The comparison device 206 can set each of the other enable signals to a logically enabled state, thereby activating a number of adders/circuits corresponding to the most-significant bits of precision to achieve the precision specified by the configuration input 204.

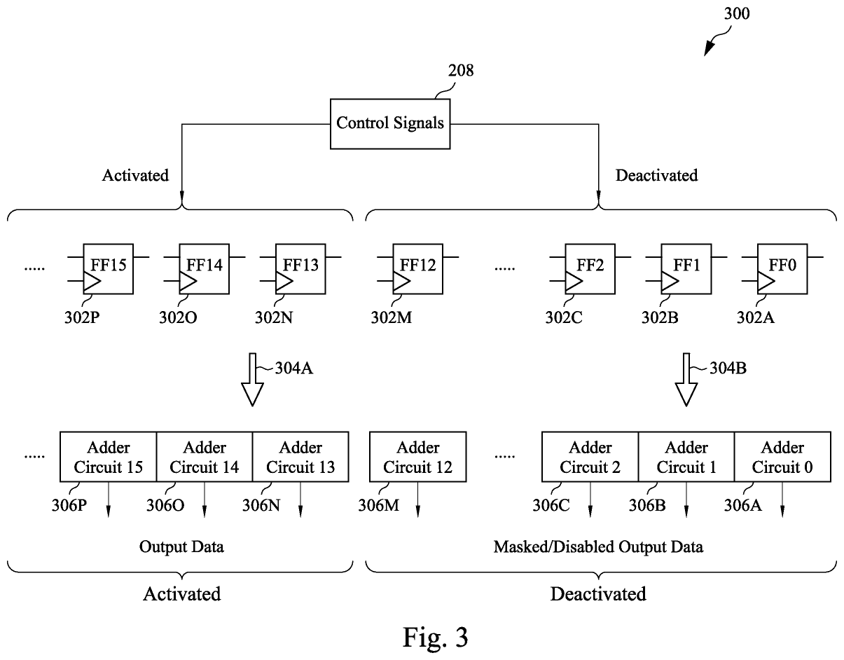

The control signals 208 can be binary signals provided to one or more circuits or devices of the MAC circuit. The control signals 208 can be any type of control signal, including but not limited to a power-enable signal, a clock-enable signal, or a device-enable signal, combinations thereof, or the like. Power-enable signals can selectively activate and/or deactivate supply power (e.g., VDD) to one or more components of the MAC circuit. Clock-enable signals can selectively activate and/or deactivate a clock signal to one or more components of the MAC circuit, preventing switching of said components and thereby conserving overall power consumption during a CIM/MAC operation. Device-enable signals can be logical input signals provided to respective devices of a MAC circuit, which cause said devices to be selectively activated or deactivated according to the logical input. A representation showing how the control signals 208 can activate and deactivate different devices/components of a MAC circuit are shown in FIG. 3.

Referring now to FIG. 3, illustrated is an example block diagram of an example system 300 of showing how example adder circuits 306A-306P of a MAC circuit (e.g., the MAC circuit 104 of FIG. 1) are controlled by the comparison circuit 200 shown in FIG. 2, in accordance with some embodiments of the present disclosure. As shown, the control signals 208 generated by the comparison device 206 of FIG. 2 can be used to control whether certain devices, such as the flip-flops 302A-302P (sometimes generally referred to as “flip-flop(s) 302”) and the adder circuits 306A-306P (sometimes generally referred to as the “adder circuit(s) 306”) are activated or deactivated. As described herein, circuits may be deactivated via logical input signals (e.g., an input to a logical “enable” port, etc.), via disabling power, or via disabling a clock signal that causes said circuits to operate.

In the example shown in FIG. 3, the precision parameter indicating the maximum precision of the MAC circuit is 23, corresponding a 23-bit mantissa of a 32-bit floating point number, while the configuration input indicates that only a precision of 10 is to be implemented, corresponding to the 10-bit of mantissa of a 16-bit floating point number. As such, the comparison device 206 of FIG. 2 can generate control signals 208 to deactivate/disable the thirteen least-significant adder circuits (and associated logic) in the MAC circuit. The control signals 208 can also include signals that enable the remaining adder circuits 306, as shown.

In some implementations, additional circuitry may be deactivated/activated according to the control signals 208. As shown, in this example, the flip-flops 302A-302M (which correspond respectively to the flip-flops 306A-306M) are disabled by corresponding control signals 208. Likewise, the flip-flops 302N-302P (which correspond respectively to the adder circuits 306N-306P) are activated by additional control signals 208. Although the flip-flops 302N-302P are shown as being activated, it should be understood that further flip-flops corresponding to more significant bits of the total sum are also activated, while in this example the flip-flops 302A-302M corresponding to the 13 least-significant bits of the total sum are deactivated as described herein. Similarly, further adder circuits corresponding to the most-significant bits of the sum are also activated by further control signals 208.

As shown, in this example the flip-flops 302N-302P provide input data 304A on a clock-cycle edge to the corresponding adder circuits 306N-306P. In this example, the flip-flops 302N-302P correspond to the 14^{th} through 16^{th} bit positions in the MAC circuit. The input data 304A provided by each of the flop-flips 302N-302P may be received from one or more of the alignment circuits (e.g., the alignment circuits 108 described in connection with FIG. 1), which can perform shift operations on input mantissa data to align the exponents such that multiple mantissas can be directed added by the adder circuits 306N-306P. In some implementations, each of the deactivated flip-flops 302A-302M can include logical elements that automatically provide a logical “zero” output as the masked input data 304B. For example, the control signals may serve as a logical input to one or more logic gates that set the output of each of the flip-flops 302A-302M, shown as the deactivated input data 304B, to a logical zero, thereby preventing further data from propagating through the system and causing power consumption.

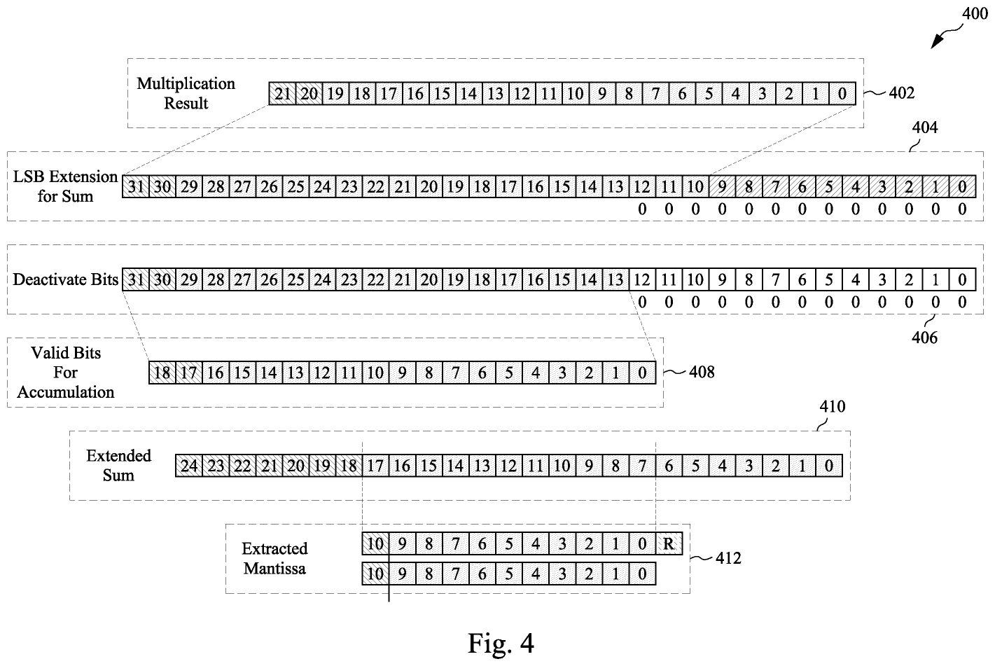

Additionally, the outputs of the adder circuits 306A-306P (and other adder circuits corresponding to more significant bits that are not shown for visual clarity) can be automatically set to certain logical values according to the control signals 208. For example, in some implementations, the adder circuits 306A-306M can include logic gates or other circuit elements that automatically set their respective output values to a logical zero value or another value that indicates the adder circuits 306A-306M are disabled. Likewise, the control signals 208 that activate the adder circuits 306N-306P can include circuits or logic gates that enable the output values of the adder circuits 306N-306P to output their respective bits of the sum. In some implementations, additional logical gates (e.g., AND gates or variations thereof) may be included at the output of each of the adder circuits 306A-306P that receive the output bits of the adder circuits 306A-306P and the control signals 208, and automatically mask (e.g., output as zero) output bits of the disabled adder circuits 306A-306N, while permitting the output bits of the enabled/activated adder circuits 306N-306P to propagate to other components/circuits of the CIM system. A data flow diagram showing how disabled adders affect bits in the sums of MAC operations is shown in FIG. 4.

Referring now to FIG. 4, illustrated is an example block dataflow diagram 400 showing how the precision of example floating point numbers are modified according to the control signals (e.g., the control signals 208) generated by a control circuit (e.g., the control circuit shown in FIG. 2), in accordance with some embodiments of the present disclosure. The example shown in the dataflow diagram 400 represents how the multiplication of two 16-bit floating-point numbers, which would result in a 32-bit floating point product, can be reduced according to the techniques described herein to produce a product having a lower bit precision, in this example a 16-bit output. Each of the boxes in the representations shown here correspond to a respective bit position in a binary number representing a corresponding value. As such, each bit position may correspond to respective logic (e.g., flip-flops, adder circuits, etc.) that generates or otherwise maintains bit data for the respective bit position in the MAC circuits described herein, in some implementations.

In this example, the multiplication result 402 includes 22 bits, and is an intermediate result of the complete multiplication of two 16-bit floating-point values. In particular, multiplication result 402 shows the multiplication of two 10-bit mantissas with the implicit hidden bit explicitly represented as a register, in this example. As such, the multiplication result includes 22-bits, with bits [0:19] corresponding to the mantissa product, and bits [20:21] corresponding to a product of the hidden bits, which here may be stored explicitly for intermediate calculations and increased precision, in some implementations.

The multiplication result 402, once generated, can then be stored in a set of registers or other logic elements that represent the multiplication result 402 with extended least-significant bits, which in this example includes a 10-bit LSB extension, for alignment purposes. Of the 1-bit extension, bits [7:9] can correspond to padding that enables the generation of 23-bit mantissa, and bits [0:6] correspond to extra bits for alignment purposes. This data is stored as the LSB extension 404 for the accumulation (sum) of the MAC operation, to preserve the precision of the floating-point data even upon performing alignment operations to cause the exponent values corresponding to each mantissa in a MAC operation to be equal. For example, during floating-point addition, the data in the mantissa can be right-shifted to increase the value of its corresponding exponent value, until that exponent value is equal to the greatest exponent value of the floating-point values to be summed. Under normal operation, the bits [0:9] of the LSB extension 404 are active and serve to receive shifted mantissa data.

As described herein, control signals (e.g., the control signals 208) can be used deactivate certain portions of MAC circuits when lower-precision values can be utilized for certain applications, including machine-learning applications. As shown, logic devices and circuits corresponding to certain bits may be deactivated in the deactivated data 406. In this example, registers corresponding to the least-significant 13-bits are deactivated, as full 32-bit precision may not be required. In this example, a 32-bit floating-point output would have a 23-bit mantissa, and therefore to achieve an output 10-bit mantissa of a 16-bit floating point value, 13 registers (shown here as bits [0:12]) can be deactivated as described herein. In some implementations, the mantissa may be left-shifted by a predetermined number of bits prior to deactivating the registers in the deactivated data 406. As shown, about one third of the registers storing the deactivated data 406, and therefore any logic corresponding thereto, can be deactivated to preserve lower precision, thereby reducing power consumption by a proportional amount.

Once the registers have been deactivated, the data that is valid for accumulation is represented in the valid bits 408, which includes 19 bits. The bits [17:18] correspond to the hidden bits from the original product, the bits [7:16] correspond to a 10-bit mantissa, and the bits [0:6] correspond to a padding extension for alignment purposes. The valid bits 408 for accumulation may be provided as input to an alignment circuit (e.g., the alignment circuit 108 of FIG. 1) to perform an alignment process following the selective deactivation of data. In some implementations, one or more registers, shifters, or other logical devices of the alignment circuit may be selectively deactivated to preserve the only the configured precision of the system.

Once aligned, the valid bits 408 can be provided as input to one or more adder circuits (e.g., the adder circuits 110) to carry out the accumulation portion of the MAC operation. As described herein, portions of the adder circuit(s) corresponding to the deactivated positions of the data (e.g., shown as bits [0:12] of the deactivated bits 406) can be disabled, reducing overall power consumption of the device. The accumulation circuit can include additional carry bit registers to maintain the carry values of a large number of summations. In this example, sixty-four summations have been performed using data similar to that shown in the valid bits 408, resulting in a carry width of 7-bits (shown here as bits [18:24]) of the extended sum 410.

Once the extended sum 410 has been calculated, an extraction circuit (e.g., the extraction circuit 112 of FIG. 1) can extract the mantissa by performing corresponding alignment processes, to align the bits and to ensure that the hidden bit (explicitly represented as bit [17]) is equal to one. The resulting mantissa value can be stored as the extracted mantissa 412. Additionally, data in the round-up bits [0:6] can be processed to generate a “round-up” value—shown here as [R]—which can indicate whether bit [0] should be set to a binary one. In this example, bits [0:9] of the extracted data correspond to the 10-bit mantissa of the 16-bit floating point output, with bit [10] explicitly representing the implicit hidden bit. Similar approaches can be utilized to generate outputs having any specified precision, including FP8_E4M3 values, for example. FP8_E4M3 values are 8-bit floating point values with a 3-bit mantissa, a 4-bit exponent, and a single sign value. In such implementations, rather than disabling the least-significant 13-bits of the LSB extension 404 data, the least-significant 20-bits of the LSB extension 404 data can be disabled, thereby achieving a 3-bit mantissa according to the FP8_E4M3 format.

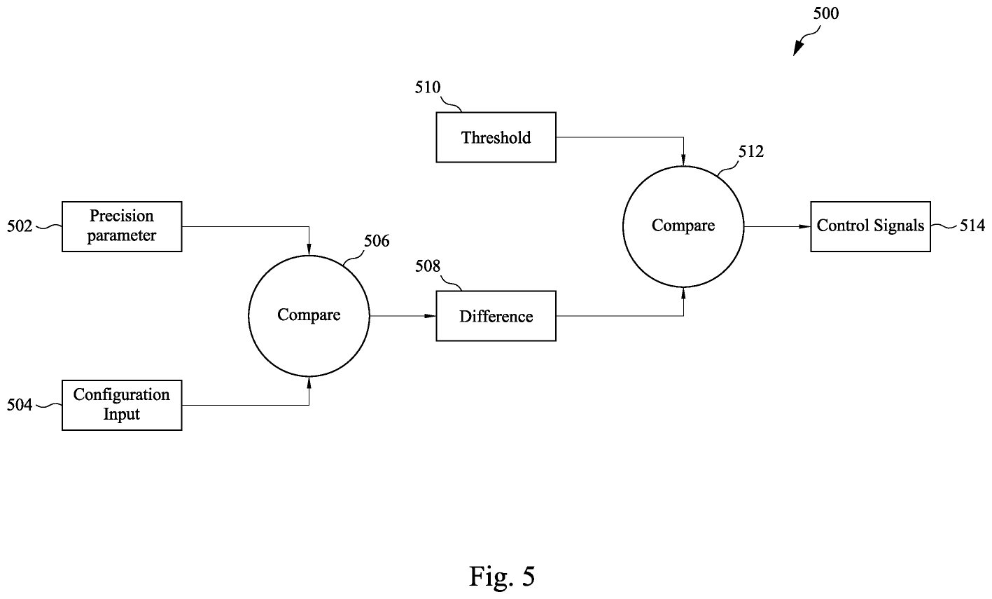

Referring to FIG. 5, illustrated is a block diagram of another example comparison circuit 500 that generates additional control signals 514 for components of an example MAC circuit (e.g., the MAC circuit 104 of FIG. 1) generated based on a threshold 510 for increasing the performance of the MAC circuit, in accordance with some embodiments of the present disclosure. The components of the comparison circuit 500 may be similar to, and include any of the structure and functionality of, the comparison circuit 200 described in connection with FIG. 2. For example, the precision parameter 502, the configuration input 504, the comparison device 506, and the control signals 514, may be similar to, and include any of the structure and functionality of, the precision parameter 202, the configuration input 204, and the comparison device 206, described in connection with FIG. 2.

In the comparison circuit 500, in addition to or as an alternative to generating the control signals 208 as described in connection with FIG. 2, the comparison device 506 can generate a difference value 508 that represents the difference between the maximum precision of the MAC circuit and the lower precision specified in the configuration input 504. For example, if the maximum precision is 23-bits (e.g., for a 32-bit floating-point output) and the specified precision is 10-bits (e.g., for a 16-bit floating-point output), the difference 508 can be equal to 13. The difference value 508 can identify the number of least-significant bit positions (and any arithmetic logic corresponding thereto) that is to be disabled/deactivated, as described herein.

In situations where the configuration input 504 specifies that a lower precision is to be utilized, fewer logical devices are activated to generate output relative to the full precision of the MAC circuit. The use of fewer logic devices enables faster clock to be utilized for the remaining logical devices that actively perform accumulation operations (e.g., adder circuits, other logic devices). As such, an additional threshold input 510 can specify a threshold number of deactivated devices at which faster clock speeds are to be activated. The threshold input 510 can be, in some implementations, a binary value stored in one or more memory elements (e.g., SRAM, registers, eFuses, etc.) that can be provided as input to a second comparison device 512. The threshold can specify a threshold number of deactivated devices in the MAC circuit that, if satisfied (e.g., matched or exceeded), can cause the activate elements of the MAC circuit to operate at an increased clock speed.

The comparison circuit 500 is shown as including a second comparison circuit 512, which may be similar to and include any of the structure and functionality of the comparison circuit 206 of FIG. 2 or the comparison circuit 506. As shown, the second comparison circuit 512 can receive one or more threshold inputs 510 and the difference 508 generated by the comparison device 506 as input. The second comparison circuit 512 can include any number of logic gates, circuit elements, or devices that can compare the difference 508 with the threshold to determine whether the difference 508 satisfies the input threshold 510. In some implementations, the input threshold 508 is satisfied when the value of the difference 508 is equal to or exceeds the input threshold 510. In some implementations, the input threshold 508 is satisfied when the value of the difference 508 exceeds the input threshold 510. In implementations where the difference 508 specifies the number of logical devices are to be activated to carry out the MAC operation, the input threshold 510 can be satisfied when the difference is less than or equal to the input threshold 510.

The second comparison circuit 512 can generate one or more control signals, which may be similar to, and include any of the structure or functionality of, the control signals 208 of FIGS. 2 and 3. For example, the second comparison circuit 512 can generate control signals 514 to selectively activate and/or deactivate one or more of the logic gates, registers, or circuits corresponding to particular bits in the MAC circuit, as described herein. In some implementations, one or more of the control signals 514 can be generated by the comparison device 506, in addition to or as an alternative to the second comparison device 514. The second comparison circuit 512 can generate additional control signals 514 for one or more clock circuits (e.g., the clock circuit 113 of FIG. 1, etc.) that selectively activate a clock signal having an increased frequency for logic associated with the “active” bits of the MAC calculation. For example, each of the registers, flip-flops, and adder circuits that are activated for a 16-bit floating point precision operation may be activated at a clock signal having an increased frequency, thereby increasing device performance, upon the input threshold 510 being satisfied. If the input threshold 510 is not satisfied, the active logic components of the MAC circuit can be activated at a normal, non-increased clock speed.

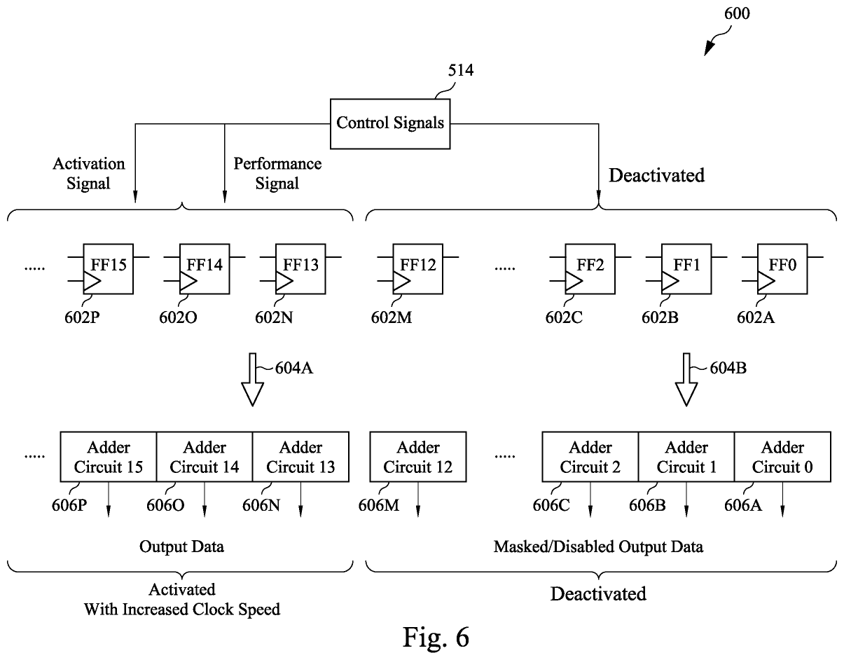

Although only a single threshold input 510 is shown here, it should be understood that any number of input thresholds may be stored or provided to the second comparison device 512, each of which may cause generation of a control signals 514 that activate logical devices at a corresponding clock speed. For example, the control signals 514 can cause active logic components to operate at a first increased clock speed when a first input threshold 510 is activated, and can cause active logic components to operate at a second increased clock speed when a second input threshold 510 is activated. The first threshold may be 13-bits of the MAC computation being deactivated and the second threshold may be 20-bits of the MAC computation being deactivated, in one example implementation. An example showing how the control signals 514 can activate circuits at different clock speeds is shown in FIG. 6.

Referring now to FIG. 6, illustrated is an example block diagram an example system 600 showing how example adder circuits 606A-606P of a MAC circuit (e.g., the MAC circuit 104 of FIG. 1) are controlled by the control signals 514 generated by a comparison circuit (e.g., the second comparison circuit 512 of FIG. 5, etc.), in accordance with some embodiments of the present disclosure. Components of the system 600 may be implemented as part of a CIM system, such as the MAC circuit 104 of the CIM system 100 shown in FIG. 1.

The example system 600 may be similar to, and include any of the structure and functionality of, the example system 300 described in connection with FIG. 3. For example, each of the flip-flips 602A-602P (sometimes generally referred to as the “flip-flop(s) 602”) may be similar to and include all of the structure and functionality of the flip flops 302A-302P. Likewise, each of the adder circuits 606A-606P (sometimes generally referred to as the “adder circuit(s) 606”) may be similar to and include all of the structure and functionality of the adder circuits 306A-306P. In this example, like the example shown in FIG. 3, the control signals 514 activate the flip flops 602N-602P (and further flip-flops corresponding to more significant bits), as well the adder circuits 606N-606P (and further adder circuits corresponding to more significant bits), while disabling the least-significant bits of the calculation (corresponding to flip-flops 602A-602M and adder circuits 606A-606M).

The activated input data 604A generated by the activated flip flips 602N-602P (and onward) propagates through to the adder circuits 606N-606P (and onward) without any masking or modification, as described in connection with FIG. 3. Likewise, the deactivated input data 604B generated by the deactivated flip flips 602A-602M is masked and/or automatically set to zero or another predetermined logic state based on the control signals 514, as described in connection with FIG. 3. Additionally, the outputs of the deactivated adder circuits 606A-606M may also be masked and/or automatically set to zero or another predetermined logic state based on the control signals 514, as described in connection with FIG. 3. As shown, the control signals 514 can include an activation signal, which activates a determined number of the most significant flip-flops and adder circuits of the circuit, and a deactivation signal, which deactivates the circuit elements corresponding to the 12 least-significant bits of the computation, in this example.

Additionally, the control signals 514 include a performance signal, which can be provided as input to one or more clock circuits to the activated logic elements themselves, which cause said logic elements to operate at an increased clock speed. In this example, the threshold for activating an increased clock speed is thirteen, e.g., disabling the logic elements corresponding to the thirteen least-significant bits of the accumulation operation. As such, the comparison circuit can generate one or more control signals 514 having one or more performance signals, which cause the activated circuit elements (e.g., the flip-flops 602N-602P and adder circuits 606N-606P, as well as elements not shown corresponding to more significant bits of the calculation) to operate at an increased clock speed.

Increasing the clock speed of the elements can be performed, for example, by providing the performance signal to one or more clock circuits (e.g., the clock circuit 113) that provide clock signals to the activated logic elements of the CIM system. For example, the clock circuit may include logic gates or other circuit elements that produce an increased clock signal having a predetermined frequency (relative to a clock signal having a frequency corresponding to normal operations, without the performance signal being activated). The clock circuit can be provided as input to each of the activated circuit elements in response to receiving the performance signal of the control signals 514.

In some implementations, the performance signal can be provided as input to each of the activated logic elements, which cause said logic elements to operate at an increased rate without necessarily increasing the clock frequency. For example, rather than changing state on one of a rising edge or falling edge of a clock signal, the activated circuit elements may instead change state on both the rising and falling edge of the clock signal, effectively doubling its data throughput, in response to receiving the performance signal. Combinations of any suitable approach for increasing the effective operating speed of various logical components may be implemented to increase the data throughput of said activated logical components in response to the performance signal. If the performance signal is not provided as part of the control signals 514, the MAC operation may be performed at a normal operating frequency.

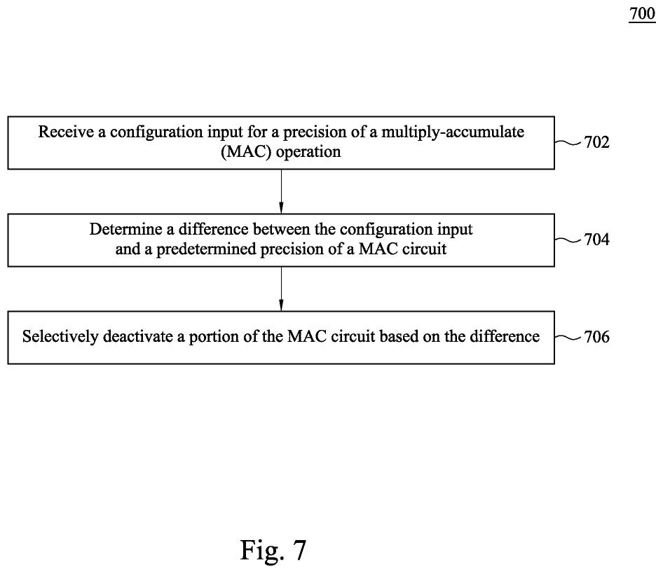

Referring to FIG. 7, illustrated is a flowchart of an example method 700 to operate the disclosed circuits described herein, in accordance with some embodiments of the present disclosure. The method 700 may be used to selectively disable various circuit elements of a CIM system to improve device power consumption and/or performance. The method 700 may be performed in connection with any of the systems, devices, circuits, or components described herein. It is understood that additional operations may be provided before, during, and after the method 700 of FIG. 7, and that some other operations may only be briefly described herein.

In brief overview, the method 700 starts with operation 702 of receiving a configuration input (e.g., the configuration input 204, the configuration input 504, etc.) a precision of a multiply-accumulate operation (e.g., as performed by the MAC circuit 104 of the CIM system 100 of FIG. 1). The method 700 proceeds with operation 704 of determining a difference (e.g., via the comparison circuit 206, the comparison circuit 506, etc.) between the configuration input and a predetermined precision (e.g., the precision parameter 202, the precision parameter 502, etc.) of a MAC circuit (e.g., the MAC circuit 104, etc.). The method 700 concludes with operation 706 of selectively deactivating a portion (e.g., the flip-flops 302A-302M, the adder circuits 306A-306M, the flip-flops 602A-602M, the adder circuits 606A-706M) of the MAC circuit based on the difference.

Referring to operation 702, a configuration input (e.g., the configuration input 204, the configuration input 504, etc.) for a precision of a multiply-accumulate operation (e.g., as performed by the MAC circuit 104 of the CIM system 100 of FIG. 1) is received. The configuration input may be stored in one or more memory elements (e.g., register(s), eFuse(s), flash memory, SRAM, DRAM, latch(es), flip-flop(s), etc.). The configuration input can specify a number of bits that are to be processed according to a CIM operation, such as the MAC operations described herein. For example, in a 32-bit floating-point value, 23-bits of mantissa data may be processed. The configuration input can specify that, to reduce the precision of the CIM operation to that of a 16-bit floating-point value, only 10-bits of mantissa data are to be processed. In some implementations, the configuration input can specify a number of least-significant bits to deactivate during the CIM operation (furthering the above example, 13-bits of mantissa to be deactivated). The configuration input can be received from one or more external configuration circuits, as part of an input to perform a CIM operation, or from a programming circuit, among others.

Referring to operation 704, the difference (e.g., via the comparison circuit 206, the comparison circuit 506, etc.) between the configuration input and a predetermined precision (e.g., the precision parameter 202, the precision parameter 502, etc.) of a MAC circuit (e.g., the MAC circuit 104, etc.) is determined. The difference can be a value that indicates a number of least-significant bits of the CIM operation that are to be deactivated. For example, if the configuration input specifies an output precision of 10-bits for the accumulation operation, and the maximum precision for the accumulation is 23-bits, the difference can be equal to 13-bits. The difference can therefore identify a number of bits that are to be deactivated during the accumulation operation. In some implementations, a comparison circuit can impose maximum and minimum limits on the difference value, so as not to exceed the minimum and maximum precision of the MAC circuit.

Referring to operation 706, a portion (e.g., the flip-flops 302A-302M, the adder circuits 306A-306M, the flip-flops 602A-602M, the adder circuits 606A-706M) of the MAC circuit can be selectively deactivated based on the difference. Selective deactivation/activation can be achieved via one or more control signals (e.g., the control signals 208, the control signals 514, etc.). To selectively deactivate a logic device (e.g., flip-flop, adder circuit, etc.), a respective deactivation signal can be provided to an enable input of the logic device. In some implementations, a deactivation signal can be provided to a clock circuit (e.g., the clock circuit 113), to selectively deactivate or stop a clock signal to each logic device of the portion of the MAC circuit. In some implementations, a deactivation signal can be provided to a power circuit (e.g., the power circuit 115), to selectively deactivate or disconnect a power signal (e.g., VDD) to each logic device of the portion of the MAC circuit.

As described in connection with FIGS. 5-6, in some implementations, a performance signal can be provided as part of the control signals to selectively cause certain logic elements to operate at an increased clock speed relative to a normal operating clock speed. In some implementations, the performance signal can be provided to a clock circuit (e.g., the clock circuit 113), to selectively increase the frequency of the clock signal to the portion of the MAC circuit, or to provide a second clock signal having an increased frequency to the portion of the MAC circuit. The performance signal can be generated, in some implementations, if the difference calculated at operation 704 satisfies a performance threshold (e.g., the threshold input 510), as described herein.

In one aspect of the present disclosure, a system is disclosed. The system includes a memory circuit storing data for a compute-in-memory (CIM) operation. The system includes an adder circuit receiving a plurality of inputs from a plurality of input devices and the memory circuit. The system includes a comparison circuit configured to receive a configuration input and generate a disable signal, the disable signal configured to disable at least a portion of the adder circuit during the CIM operation.

In another aspect of the present disclosure, a circuit is disclosed. The circuit includes a first adder circuit receiving a first set of input bits and a second adder circuit receiving a second set of input bits. The circuit can include a comparison circuit configured to receive a first configuration input, determine that a difference between the first configuration input and a predetermined precision value satisfies a predetermined threshold, and, responsive to determining that the difference satisfies the predetermined threshold, generate one or more signals to deactivate the second adder circuit and activate the first adder circuit.

In yet another aspect of the present disclosure, a method is disclosed. The method includes receiving a configuration input for a precision of a MAC operation. The method includes determining a difference between the configuration input and a predetermined precision of a MAC circuit. The method includes selectively deactivating a portion of the MAC circuit based on the difference.

As used herein, the terms “about” and “approximately” generally mean plus or minus 10% of the stated value. For example, about 0.5 would include 0.45 and 0.55, about 10 would include 9 to 11, about 1000 would include 900 to 1100.

The foregoing outlines features of several embodiments so that those skilled in the art may better understand the aspects of the present disclosure. Those skilled in the art should appreciate that they may readily use the present disclosure as a basis for designing or modifying other processes and structures for carrying out the same purposes and/or achieving the same advantages of the embodiments introduced herein. Those skilled in the art should also realize that such equivalent constructions do not depart from the spirit and scope of the present disclosure, and that they may make various changes, substitutions, and alterations herein without departing from the spirit and scope of the present disclosure.

What is claimed is:

1. A system, comprising:
a memory circuit storing data for a compute-in-memory (CIM) operation;
an adder circuit receiving a plurality of inputs from a plurality of input devices and the memory circuit; and
a comparison circuit configured to receive a configuration input and generate a disable signal, the disable signal configured to disable at least a portion of the adder circuit during the CIM operation.

2. The system of claim 1, further comprising a second memory circuit storing the configuration input.

3. The system of claim 1, wherein:
the configuration input identifies a number of active bits;
the adder circuit is configured to add a predetermined number of bits; and
the disable signal is configured to disable a subset of the predetermined number of bits of the adder circuit based on the number of active bits.

4. The system of claim 3, wherein the comparison circuit is configured to identify the subset of the predetermined number of bits based on a difference between the predetermined number of bits and the number of active bits.

5. The system of claim 1, wherein the adder circuit is configured to add at least thirty-two bits, and the disable signal is configured to disable at least thirteen of the at least thirty-two bits.

6. The system of claim 1, wherein the plurality of input devices comprise a plurality of flip-flops, and wherein the disable signal is further configured to disable at least a subset of the plurality of flip-flops.

7. The system of claim 1, wherein the adder circuit is configured to add floating point values represented by the plurality of inputs, and wherein the disable signal is configured to disable at least the portion of the adder circuit corresponding to a mantissa of a floating point value during the CIM operation.

8. The system of claim 1, further comprising a multiplier circuit that provides at least a subset of the plurality of inputs.

9. The system of claim 8, wherein the multiplier circuit comprises an alignment circuit that generates at least the portion of the plurality of inputs.

10. The system of claim 1, wherein the adder circuit comprises an adder tree circuit.

11. A circuit, comprising:
a first adder circuit receiving a first set of input bits and a second adder circuit receiving a second set of input bits; and
a comparison circuit configured to:
receive a first configuration input;
determine that a difference between the first configuration input and a predetermined precision value satisfies a predetermined threshold; and
responsive to determining that the difference satisfies the predetermined threshold, generate one or more signals to deactivate the second adder circuit and activate the first adder circuit.

12. The circuit of claim 11, wherein the one or more signals deactivate a clock circuit corresponding to the second adder circuit.

13. The circuit of claim 11, wherein the one or more signals deactivate a power supply of the second adder circuit.

14. The circuit of claim 11, wherein at least one of the one or more signals is provided to an enable input of the second adder circuit to deactivate the second adder circuit.

15. The circuit of claim 11, wherein the first configuration input is stored in one or more of an eFuse, a flash memory, or a latch.

16. The circuit of claim 11, wherein the one or more signals activate an increased clock speed for the first adder circuit.

17. A method, comprising:
receiving a configuration input for a precision of a multiply-accumulate (MAC) operation;
determining a difference between the configuration input and a predetermined precision of a MAC circuit; and
selectively deactivating a portion of the MAC circuit based on the difference.

18. The method of claim 17, wherein selectively deactivating the portion of the MAC circuit comprises selectively deactivating power to the portion.

19. The method of claim 17, wherein selectively deactivating the portion of the MAC circuit comprises selectively disabling a clock signal for the portion.

20. The method of claim 17, wherein a number of devices deactivated as part of the portion of the MAC circuit corresponds to the precision of the MAC operation.
